(19) United States
(12) Patent Application Publication
(10) Pub. No.: US 2024/0189949 A1
(43) Pub. Date: Jun. 13, 2024

(54) WELDING ELECTRODE AND SPOT-WELDING DEVICE

(71) Applicant: University Public Corporation Osaka, Osaka-shi, Osaka (JP)

(72) Inventors: Masakazu SHIBAHARA, Sakai-shi (JP); Kazuki IKUSHIMA, Sakai-shi (JP); Ryoma TANAKA, Sakai-shi (JP); Atsushi KAWAHARA

(21) Appl. No.: 18/279,643

(22) PCT Filed: Feb. 16, 2022
(86) PCT No.: PCT/JP2022/006203

§ 371 Date: Aug. 31, 2023

(30) Foreign Application Priority Data
Mar. 4, 2021 (JP) 2021-034592

(51) Int. Cl. B23K 35/02; B23K 11/30

(52) U.S. Cl. CPC B23K 35/0205; B23K 11/3009

(57) ABSTRACT

The present invention provides a welding electrode capable of spot-welding a workpiece having a surface oxide film with stable welding quality, the welding electrode allowing general tip dressers to be used. The welding electrode of the present invention is used for spot welding of a workpiece. The welding electrode includes an end face provided so as to contact the workpiece, and at least one elongated groove provided in the end face or a plurality of blind holes provided in the end face. A depth of the groove or a depth of the blind holes is 0.5 mm or more and 20 mm or less. A ratio (d/w) of the depth d of the groove to a width w of the groove or a ratio (d/s) of the depth d of the blind holes to a size s of the blind holes is 2 or more.

### TECHNICAL FIELD

The present invention relates to a welding electrode and a spot welding apparatus.

### BACKGROUND ART

Aluminum alloy sheets have a specific gravity of about one third of that of steel sheets, and are attracting attention as a lightweight material for automobile bodies and the like. On the other hand, spot welding is a welding method that utilizes resistance heat generated by applying a large current to the welding point, and is often used in the assembly of automobile bodies and the like. However, since aluminum alloy sheets have a surface oxide film, the current is partially blocked by the surface oxide film when spot-welding aluminum alloy sheets, making nugget formation unstable. This results in unstable welding quality.

In spot welding of aluminum alloy sheets, a welding method is known in which a welding electrode (tip) is pressed against an aluminum alloy sheet so that a convex portion of the electrode surface penetrates the surface oxide film of the aluminum alloy sheet, thereby reducing electrical resistance at the boundary between the alloy sheet and the welding electrode (for example, see Patent Literature 1).

Further, the end face of the welding electrode is burnt and contaminated during repeated spot welding. If the contamination becomes severe, the electrical resistance between the welding electrode and the workpiece increases, preventing sufficient current from flowing to melt the workpiece. Therefore, it is necessary to perform a treatment (dressing) for removing the surface contamination by shaving the end face of the welding electrode using a tip dresser. This dressing needs to be performed so that the end face of the welding electrode has the initial shape in order not to change the welding characteristics.

### CITATION LIST

### Patent Literature

Patent Literature 1: US 2013/0306604 A1

### SUMMARY OF INVENTION

### Technical Problem

However, when dressing a welding electrode having a convex portion on its end face, it is necessary to shave the end face without changing the shape of the convex portion, which requires the use of a special tip dresser, and general tip dressers cannot be used.

The present invention has been made in view of such circumstances, and provides a welding electrode capable of spot-welding a workpiece having a surface oxide film with stable welding quality, the welding electrode allowing general tip dressers to be used.

### Solution to Problem

The present invention provides a welding electrode used for spot welding of a workpiece. The welding electrode includes an end face provided so as to contact the workpiece, and at least one elongated groove provided in the end face or a plurality of blind holes provided in the end face, a depth of the groove or a depth of the blind holes is 0.5 mm or more and 20 mm or less, and a ratio (d/w) of the depth d of the groove to a width w of the groove or a ratio (d/s) of the depth d of the blind hole to a size s of the blind hole is 2 or more.

### Advantageous Effects of Invention

Since the welding electrode of the present invention has at least one elongated groove or a plurality of blind holes in the end face, by pressing the end face of the welding electrode against a workpiece having a surface oxide film, the workpiece can be deformed so that a part of the workpiece enters the groove or the holes. Due to this deformation, a part of the surface oxide film of the workpiece is cut, and a portion where the metal of the workpiece and the welding electrode are in direct contact without intervention of the surface oxide film can be formed. This reduces the electrical resistance at the boundary between the welding electrode and the workpiece, allowing a large current to be stably applied to the workpiece. As a result, a large-sized nugget can be stably formed, and the workpiece having the surface oxide film can be spot-welded with stable welding quality. Further, the current density of the current applied to the workpiece can be efficiently increased, and a large nugget can be formed. Further, heat generation at the boundary between the welding electrode and the workpiece can be suppressed, and adhesion between the welding electrode and the workpiece can be suppressed.

A depth of the groove or a depth of the blind holes is 0.5 mm or more and 20 mm or less. Since the groove has a sufficiently deep depth, the groove is not lost even when the end face of the welding electrode is shaved using a tip dresser. Therefore, even when spot welding is performed after dressing is performed, a part of the surface oxide film of the workpiece can be cut by the groove, and a portion where the metal of the workpiece and the welding electrode are in direct contact without intervention of the surface oxide film can be formed. As a result, even after dressing, the workpiece having the surface oxide film can be spot-welded with stable welding quality.

A ratio (d/w) of the depth d of the groove to a width w of the groove or a ratio (d/s) of the depth d of the blind holes to a size s of the blind holes is preferably 2 or more. This allows a larger contact area between the workpiece and the welding electrode, which increases the amount of heat dissipation from the surface portion of the workpiece to the welding electrode. As a result, surface scattering can be suppressed.

### BRIEF DESCRIPTION OF THE DRAWINGS

FIG. 1 is a schematic perspective view of a welding electrode of an embodiment of the present invention.

FIG. 2 is a schematic cross-sectional view of the welding electrode, taken along dashed line A-A in FIG. 1

FIG. 3 is a schematic end view of a welding electrode according to an embodiment of the present invention.

FIG. 4 is a schematic cross-sectional view of the welding electrode, taken along dashed line X-X in FIG. 3.

FIGS. 5(a) to 5(d) are schematic end views of welding electrodes according to embodiments of the present invention.

FIG. 6 is a schematic diagram of a welding apparatus according to an embodiment of the present invention.

FIG. 7 is an enlarged cross-sectional view of area B enclosed by the dashed line in FIG. 6.

FIG. 8 is an enlarged cross-sectional view of area C enclosed by the dashed line in FIG. 7.

FIG. 9 is a partial cross-sectional view of a tip dresser when shaving the end face of the welding electrode.

FIGS. 10(a) to 10(d) are schematic perspective views of welding electrodes subjected to three-dimensional spot welding analysis.

FIG. 11 is an analytical model used in the three-dimensional spot welding analysis.

FIGS. 12(a) to 12(d) are maximum attained temperature distributions obtained by the three-dimensional spot welding analysis.

FIG. 13 is a graph showing the change of the diameter of the molten region with time.

FIG. 14 is a graph showing the change of the diameter of the molten region with time.

FIG. 15 is a graph showing the maximum attained temperature distribution of the surface of the workpiece.

FIG. 16 is a graph showing the maximum attained temperature distribution of the surface of the workpiece.

FIG. 17 is an analysis result of the shape of the surface of the workpiece pressed by the welding electrode.

### DETAILED DESCRIPTION

A welding electrode of the present invention is a welding electrode used for spot welding of a workpiece. The welding electrode has an end face provided so as to contact the workpiece, and at least one elongated groove provided in the end face or a plurality of blind holes provided in the end face, the depth of the groove or the depth of the blind holes is 0.5 mm or more and 20 mm or less, and the ratio (d/w) of the depth (d) of the groove to the width (w) of the groove or the ratio (d/s) of the depth (d) of the blind holes to the size (s) of the blind holes is 2 or more.

It is preferable that the welding electrode has a plurality of grooves including the groove, and the plurality of grooves are provided in a grid pattern. This allows the surface oxide film of the workpiece to be cut in a grid pattern during spot welding, forming a nugget with a stable shape.

The width of the grooves or the size of the blind holes is 0.01 mm or more and 2 mm or less. This allows a larger contact area between the workpiece and the welding electrode, which increases the amount of heat dissipation from the surface portion of the workpiece to the welding electrode. As a result, surface scattering can be suppressed.

It is preferable that the plurality of grooves or the plurality of blind holes are provided so that the density of the grooves or the density of the blind holes at the center of the end face is higher. This makes it possible to reduce the electrical resistance at the boundary between the workpiece and the welding electrode, and to form a nugget having a large diameter.

The end face preferably has a dome shape having a radius of curvature of 15 mm or more and 60 mm or less.

The present invention also provides a welding apparatus including the welding electrode of the present invention and a power supply device electrically connected to the welding electrode. The welding electrode and the power supply device are provided such that the output current of the power supply device is applied to the workpiece via the welding electrode.

An embodiment of the present invention will be described below with reference to the drawings. The configurations shown in the drawings and the following description are illustrative, and the scope of the present invention is not limited to those shown in the drawings and the following description.

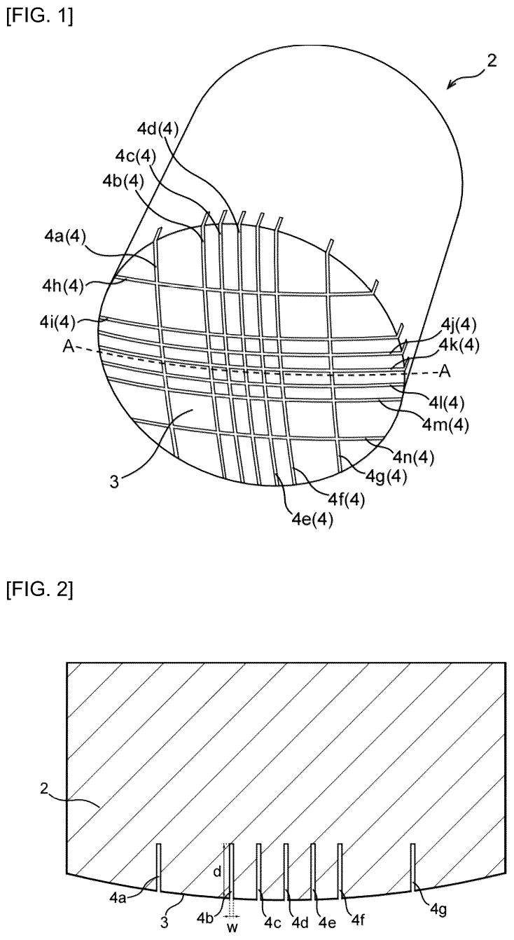

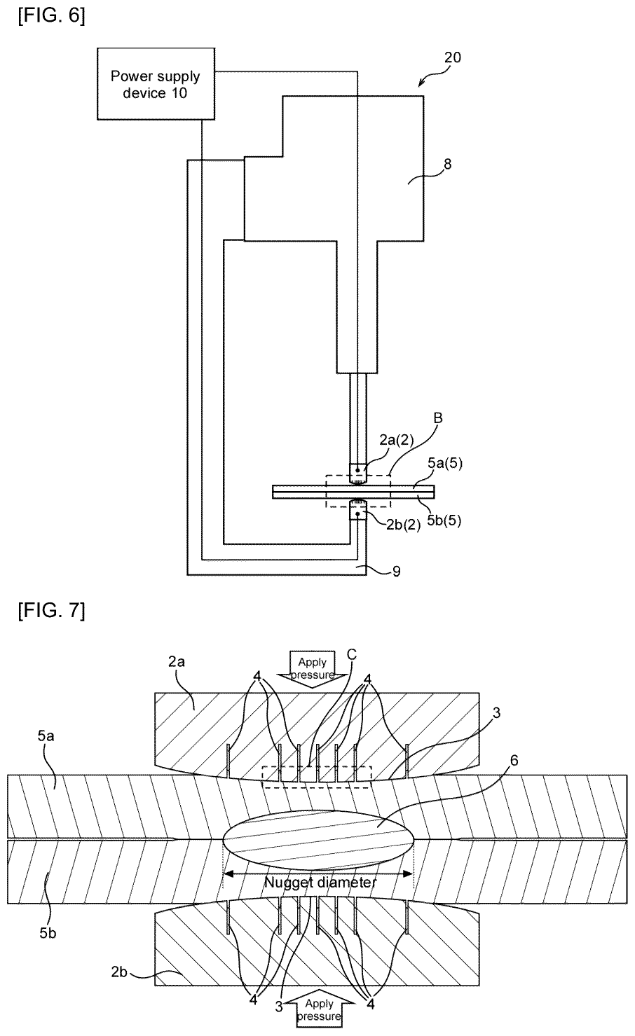

FIG. 1 to FIG. 5 are schematic diagrams of welding electrodes of the present embodiment and the like, and FIG. 6 to FIG. 8 are schematic diagrams of a welding apparatus and the like.

A welding electrode 2 of the present embodiment is a welding electrode used for spot welding of a workpiece 5. The welding electrode 2 is characterized in that it has an end face 3 provided so as to contact the workpiece 5, and at least one elongated groove 4 provided in the end face 3 or a plurality of blind holes 11 provided in the end face 3, and the depth of the groove 4 or the depth of the blind holes 11 is 0.5 mm or more and 20 mm or less, and the ratio (d/w) of the depth (d) of the groove 4 to the width (w) of the groove 4 or the ratio (d/s) of the depth (d) of the blind holes 11 to the size (s) of the blind holes 11 is 2 or more.

A welding apparatus 20 of the present embodiment is characterized in that it includes at least one welding electrode 2 and a power supply device 10 electrically connected to the welding electrode 2, and the welding electrode 2 and the power supply device 10 are provided such that an output current of the power supply device 10 is applied to the workpiece 5 via the welding electrode 2.

The welding apparatus 20 is an apparatus that performs resistance spot welding. The welding apparatus 20 may be a robotic gun, a portable gun, or a stationary spot welder. The welding apparatus 20 may be a C-type or an X-type (the welding apparatus 20 illustrated in FIG. 6 is a C-type). In addition, the welding apparatus 20 may be an apparatus that performs double-sided spot welding or an apparatus that performs single-sided spot welding.

Workpieces 5a and 5b are metal sheets. In the present embodiment, the workpieces 5a and 5b are metal sheets having a surface oxide film, such as aluminum alloy sheets.

When the welding apparatus 20 is an apparatus that performs double-sided spot welding as illustrated in FIG. 6, the welding apparatus 20 is provided so that two welding electrodes 2a and 2b apply a current to two workpieces 5a and 5b between the welding electrodes 2a and 2b while holding a stack of the workpieces 5a and 5b therebetween by applying pressure. When a current is applied to the workpieces 5a and 5b by the welding apparatus 20, Joule heat is generated at the contact surface between the workpieces 5a and 5b (this portion has the largest electrical resistance), the temperature near the contact surface rapidly increases, melting the workpieces 5a and 5b in this region to form a molten region. When the current application is stopped, the molten region is cooled and solidified to form a nugget 6 as shown in FIG. 7. The workpieces 5a and 5b are joined by this nugget 6. Therefore, stable formation of large nuggets 6 stabilizes welding quality. When the workpiece 5 is an aluminum alloy sheet, the heat generated between the workpieces 5a and 5b easily diffuses due to the high thermal conductivity of aluminum alloy, which prevents the nugget 6 from becoming large.

The spot welding by the welding apparatus 20 can be performed in such a manner that the surface of the workpiece 5 brought into contact with the welding electrode 2 does not melt. This prevents the molten region from reaching the surface of the workpiece 5, thereby suppressing surface scattering. At the contact surface between the workpiece 5 and the welding electrode 2, the heat of the workpiece 5 is dissipated to the welding electrode 2 and the temperature rise of the surface of the workpiece 5 is suppressed, so that the surface of the workpiece 5 can be prevented from melting.

When the welding apparatus 20 is an apparatus that performs single-sided spot welding, the welding apparatus 20 is configured to apply a current to the workpieces 5a and 5b while one of two workpieces 5a and 5b is grounded and the apparatus presses the welding electrode 2 against the other workpiece 5. In this case, the welding apparatus 20 has one welding electrode 2. In this case, a molten region is formed between the workpieces 5a and 5b, and the molten region is cooled to form the nugget 6 similarly to the double-sided spot welding.

The welding electrode 2 (tip) is an electrode for contacting and pressing the workpieces 5a and 5b and applying a current to the workpieces 5a and 5b. Also, the welding electrode 2 is provided so as to be replaceably attachable to the welding device 20. The welding electrode 2 has an end face 3 provided to contact the workpiece 5. The welding electrode 2 can have a cylindrical shape. One of the upper surface and the lower surface of the cylindrical shape is the end face 3, and the other is the surface connected to the welding apparatus 20. The end face 3 may be a flat surface, a curved surface, a combination of flat and curved surfaces, or a combination of two or more curved surfaces with different radii of curvature.

Welding electrodes 2 are classified according to the shape of the end face 3 (contact surface). The welding electrode 2 may be a flat type (F), a radius type (R), a dome type (D), a dome radius type (DR), a cone flat type (CF), or a cone radius type (CR). The end face 3 preferably has a dome shape with a radius of curvature of 15 mm or more and 60 mm or less.

The material of the welding electrode 2 is not particularly limited as long as the welding electrode 2 can apply a current to the workpieces 5a and 5b, and examples thereof include copper, copper alloys (a copper alloy with 0.4 wt % to 1.2 wt % chromium added to copper, a copper alloy with 0.02 wt % to 0.2 wt % zirconium added to copper, a copper alloy with 0.7 wt % to 1.2 wt % chromium and 0.06 wt % to 0.15 wt % zirconium added to copper, alumina dispersion strengthened copper, and the like), tungsten, tungsten alloys, hafnium, hafnium alloys, and tungsten carbide. Further, the welding electrode 2 can have such a strength that it hardly deforms even when it is pressed against the workpieces 5a and 5b.

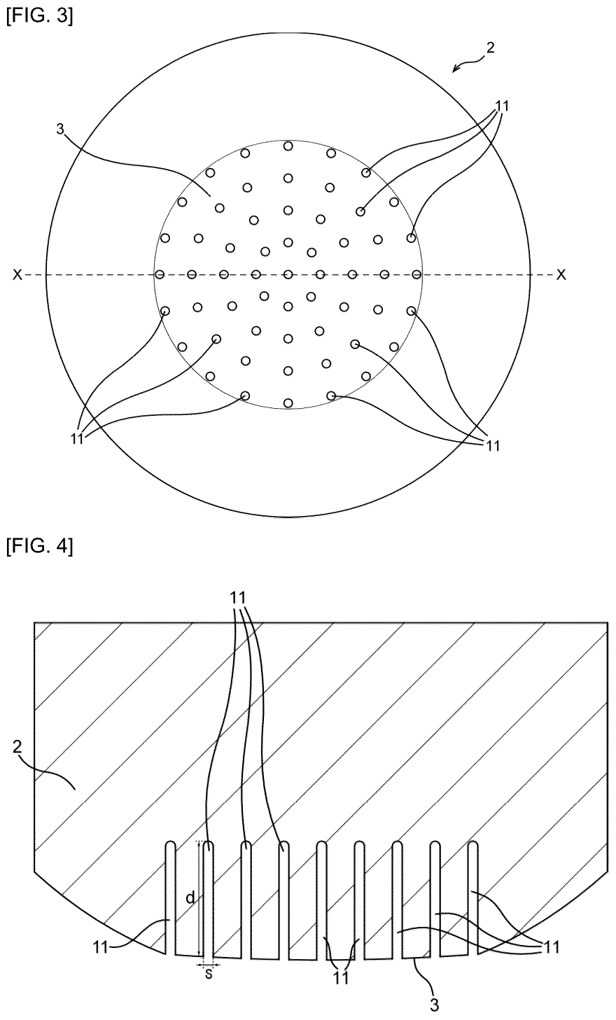

The welding electrode 2 has at least one elongated groove 4 provided in the end face 3 or a plurality of blind holes 11 provided in the end face 3. For example, a plurality of elongated grooves 4 are formed in the end face 3 of the welding electrode 2 shown in FIG. 1 and FIG. 2. Further, for example, a plurality of blind holes 11 are formed in the end face 3 of the welding electrode 2 shown in FIG. 3 and FIG. 4. Both the elongated groove 4 and the blind hole 11 may be formed in the end face 3.

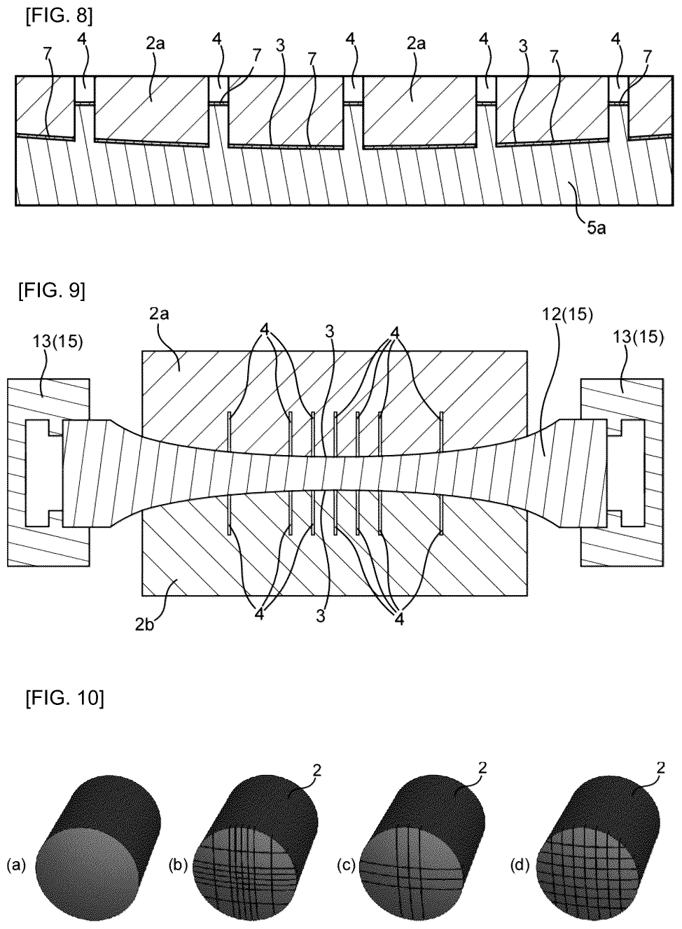

By pressing the workpiece 5 having the surface oxide film 7 with the end face 3, the workpiece 5 is deformed so that a part of the workpiece 5 enters the grooves 4 or the blind holes 11. For example, the workpiece 5a is deformed as shown in FIG. 8. Due to this deformation, a part of the surface oxide film 7 of the workpiece 5 is cut, and a portion where the metal of the workpiece 5 and the welding electrode 2 are in direct contact without intervention of the surface oxide film 7 can be formed. This reduces the electrical resistance at the boundary between the welding electrode 2 and the workpiece 5, allowing a large current to be stably applied to the workpiece 5. As a result, a large-sized nugget 6 can be stably formed, and the workpiece 5 having the surface oxide film 7 can be spot-welded with stable welding quality. Further, the current density of the current applied to the workpiece 5 can be efficiently increased, and a large nugget 6 can be formed. Further, heat generation at the boundary between the welding electrode 2 and the workpiece 5 can be suppressed, and adhesion between the welding electrode 2 and the workpiece 5 can be suppressed.

The width w of the groove 4 is, for example, 0.01 mm or more and 5 mm or less, 0.01 mm or more and 3 mm or less, 0.01 mm or more and 2 mm or less, 0.01 mm or more and 1 mm or less, or 0.01 mm or more and 0.5 mm or less. The width w of the groove 4 is preferably 0.01 mm or more and 0.5 mm or less. The size of the blind hole 11 is, for example, 0.01 mm or more and 5 mm or less, 0.01 mm or more and 3 mm or less, 0.01 mm or more and 2 mm or less, 0.01 mm or more and 1 mm or less, or 0.01 mm or more and 0.5 mm or less. The size of the blind hole 11 is preferably 0.01 mm or more and 0.5 mm or less. This allows a larger contact area between the workpiece 5 and the welding electrode 2, which increases the amount of heat dissipation from the surface portion of the workpiece 5 to the welding electrode 2. As a result, the molten region formed between the workpieces 5a and 5b can be prevented from reaching the surfaces of the workpieces 5a and 5b, thus suppressing surface scattering.

When the blind hole 11 has a circular shape, the size of the blind hole 11 is the diameter of the blind hole 11. When the blind hole 11 has a square shape or a triangular shape, the size of the blind hole 11 is the length of one side of the blind hole 11. When the blind hole 11 has another shape, the size of the blind hole 11 can be the diameter of the circumscribed circle of the shape of the blind hole 11.

While spot welding is repeated, the tip of the welding electrode 2 is burnt and contaminated. If the contamination becomes severe, the electrical resistance at the boundary between the welding electrode 2 and the workpiece 5 increases, preventing sufficient current from flowing to melt the workpiece 5. Therefore, it is necessary to perform a treatment (dressing) for removing contamination on the surface by shaving the end face 3 of the welding electrode 2 using a tip dresser.

FIG. 9 is a schematic cross-sectional view of the tip dresser 15 and the welding electrode 2 when the end face 3 of the welding electrode 2 is shaved by the tip dresser 15. The tip dresser 15 shown in FIG. 9 is a type of tip dresser that simultaneously shaves the end faces 3 of the welding electrodes 2a and 2b. The tip dresser 15 includes a rotary cutter 12 having a shape that matches the shape of the welding electrode 2.

By rotating the rotary cutter 12 pressed by the end faces 3 of the welding electrodes 2a and 2b, the end faces 3 of the welding electrodes 2a and 2b can be shaved to remove contamination from the end faces 3 of the welding electrodes 2a and 2b. In addition, even if the end face 3 of the welding electrode 2a or 2b is deformed by the spot welding, the shape of the end face 3 can be returned to the initial shape by shaving the end face 3 with the rotary cutter 12.

The depth d of the groove 4 formed in the end face 3 or the depth d of the blind hole 11 formed in the end face 3 is 0.5 mm or more and 20 mm or less, preferably 1 mm or more and 20 mm or less. Since the groove 4 or the blind hole 11 has a sufficiently deep depth as described above, the groove 4 or the blind hole 11 is not lost even when the end face 3 of the welding electrode 2 is shaved using the tip dresser 15. Therefore, even when spot welding is performed after dressing is performed, a part of the surface oxide film 7 of the workpiece 5 can be cut by the groove 4, and a portion where the metal of the workpiece 5 and the welding electrode 2 are in direct contact without intervention of the surface oxide film 7 can be formed. As a result, even after the dressing, the workpiece 5 having the surface oxide film 7 can be spot-welded with stable welding quality.

Further, the end face 3 of the welding electrode 2 has no convex portion on the surface to be shaved by the tip dresser 15. This prevents the shape of the end face 3 from changing due to dressing.

The ratio (d/w) of the depth d of the groove 4 to the width w of the groove 4 or the ratio (d/s) of the depth d of the blind hole 11 to the size s of the blind hole 11 is preferably 2 or more, more preferably 4 or more, and still more preferably 10 or more. This allows the groove 4 or the blind hole 11 to be deep enough to prevent the groove 4 from being lost due to dressing. In addition, the contact area between the workpiece 5 and the welding electrode 2 can be increased.

The length of the groove 4 formed in the end face 3 may be, for example, 2 mm or more and 100 mm or less. The groove 4 may be a straight line or a curved line.

The pattern of the grooves 4 on the end face 3 is not particularly limited, but may be, for example, a grid pattern in which a plurality of grooves 4 in the lengthwise direction intersects a plurality of grooves 4 in the crosswise direction. This allows the surface oxide film 7 of the workpiece 5 to be cut in a grid pattern during spot welding, forming a nugget 6 with a stable shape. For example, on the end face 3 of the welding electrode 2 illustrated in FIG. 1, a grid pattern in which grooves 4a to 4g in the lengthwise direction intersect grooves 4h to 4n in the crosswise direction is formed.

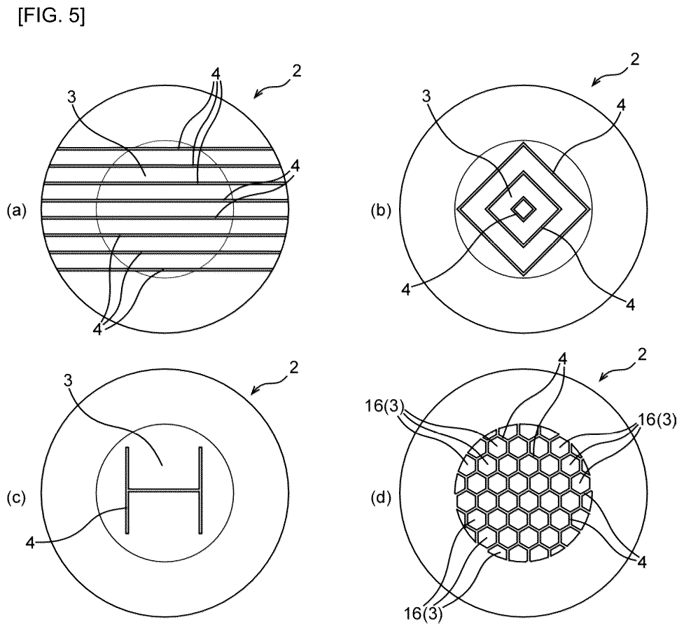

The pattern of the grooves 4 on the end face 3 may be a stripe shape in which a plurality of grooves 4 are provided in parallel as shown in FIG. 5(a), a shape in which grooves 4 extend in squire shapes as shown in FIG. 5(b), or an alphabet shape as shown in FIG. 5(c). Further, as shown in FIG. 5(d), when the welding electrode 2 has a plurality of convex portions 16, and the upper surfaces of the plurality of convex portions 16 form the end face 3, the groove 14 may be disposed between two adjacent convex portions 16. Further, the groove 4 or blind hole 11 may be used to draw a trademark, an emblem, or the like on the end face 3. The pattern of grooves 4 or blind holes 11 will remain on the workpiece 5, allowing it to leave a mark indicating the origin of the workpiece.

The pattern of the grooves 4 on the end face 3 or the pattern of the blind holes 11 on the end face 3 can be provided so that the density of the grooves 4 or the blind holes 11 at the center of the end face 3 is higher. Also, the pattern of the grooves 4 on the end face 3 or the pattern of the blind holes 11 on the end face 3 can be provided so that the spacing between the grooves 4 or the blind holes 11 near the center of the end face 3 is narrow and the spacing between the grooves 4 or the blind holes 11 far from the center of the end face 3 is narrow. This allows formation of a nugget 6 having a large diameter and prevents the surface temperature of the workpiece 5 from becoming too high.

The welding electrode 2 can be manufactured, for example, by processing and cutting a copper or copper alloy round bar. The groove 4 or the blind hole 11 of the end face 3 can be formed by shaving the end face 3 by, for example, micro-cutting, wire cutting, laser machining, drilling, electrical discharge machining, plasma machining, electrolytic machining, or the like. The welding electrode 2 having the groove 4 or the blind hole 11 in the end face 3 can also be manufactured by hot press molding, casting, or the like.

### Three-Dimensional Spot Welding Analysis

Three-dimensional analysis of spot welding of aluminum alloys was performed using idealized explicit finite element method (FEM).

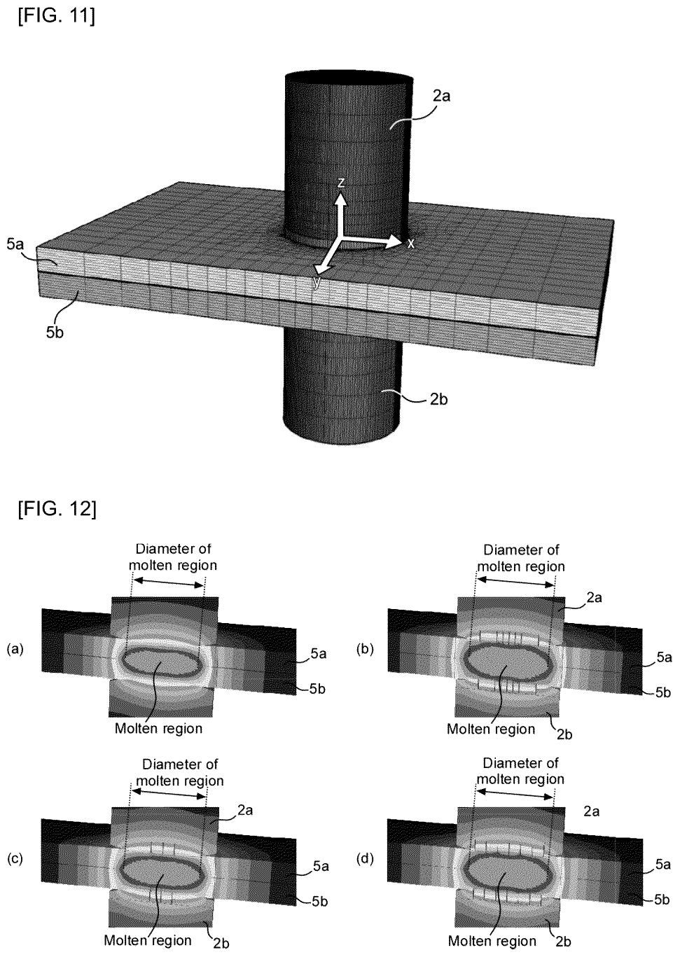

In the analysis, the models shown in FIGS. 10(a) to 10(d) were used as models of the welding electrode, and the model shown in FIG. 11 was used as a whole. The number of nodes in each analytical model is about 250000, and the number of elements is about 260000.

The material of the welding electrode was copper, the diameter of the welding electrode was 12 mm, the radius of curvature of the end face of the welding electrode was 25 mm, and the width of the groove of the end face was 0.1 mm. The welding electrode shown in FIG. 10(a) is a conventional welding electrode, and no groove is formed in the end face. The welding electrodes shown in FIGS. 10(b) to 10(d) are welding electrodes of the present invention, and have different groove patterns. In the welding electrodes shown in FIGS. 10(b) and 10(c), grooves in a grid pattern are formed so that the density of the grooves at the center of the end face is higher than that in the other areas, and the number of the grooves in the analytical model of FIG. 10(b) is larger than that in the analytical model of FIG. 10(c). Further, in the analytical model shown in FIG. 10(b), the spacing between grooves near the center of the end face is narrow, and the spacing between grooves far from the center of the end face is wide. In the analytical model shown in FIG. 10(d), a grid of equally spaced grooves is formed.

As the workpiece, a model of two stacked 5000 series aluminum alloy sheets of 2.3 mm thickness was used. The melting point of the aluminum alloy was 600° C. The pressure (applied force) for holding the workpiece between the two welding electrodes was 3 kN. The current applied to the workpieces was 4 kA from 0 ms to 100 ms after the start of current application, and the current applied to the workpiece was 15 kA from 100 ms to 400 ms after the start of current application.

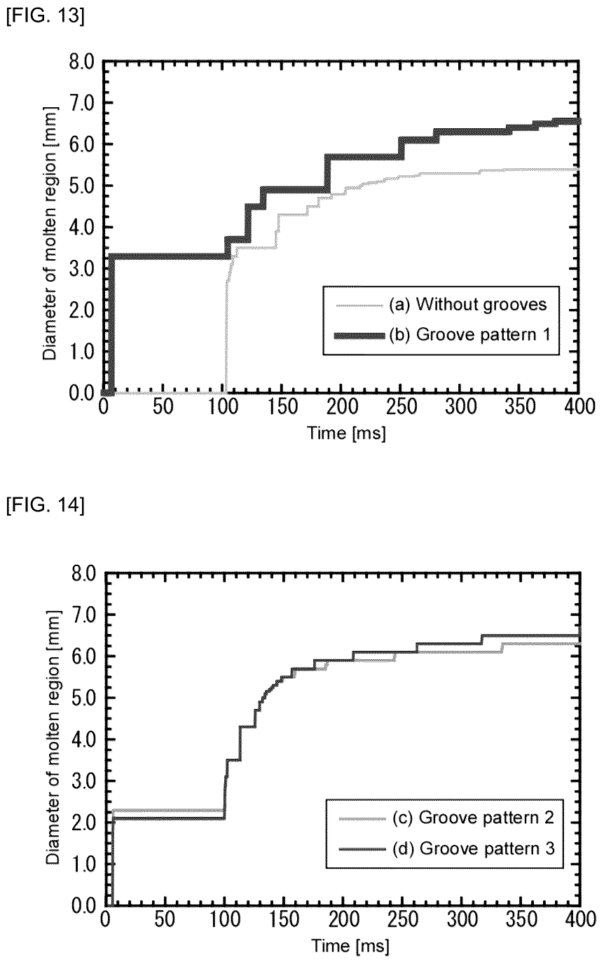

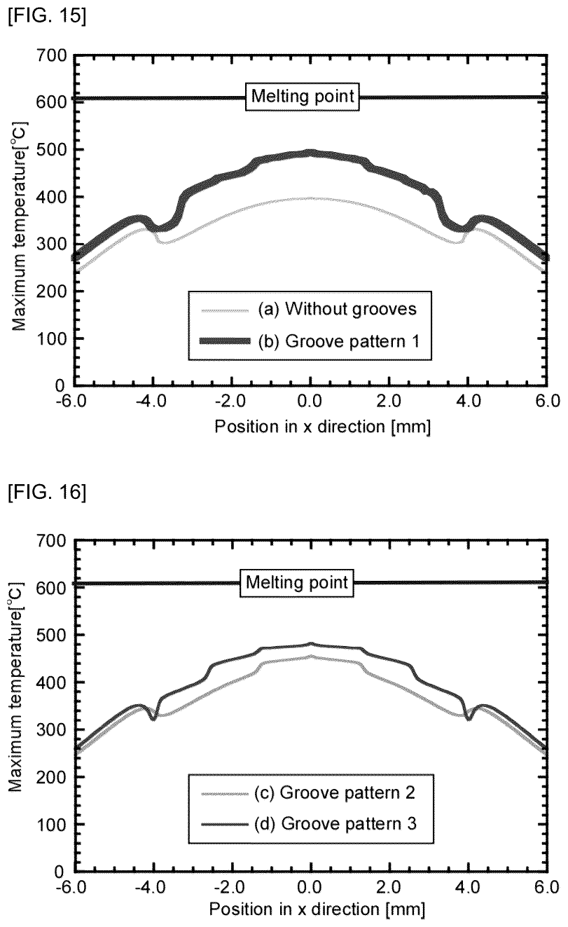

FIG. 12(a) shows the maximum attained temperature distribution of a cross section including the molten region during current application in the analysis using the welding electrode (without grooves) shown in FIG. 10(a), the step line (a) in FIG. 13 shows the change in the diameter of the molten region in this analysis, and the curve (a) in FIG. 15 shows the maximum attained temperature distribution of the surface (the surface in contact with the welding electrode) of the aluminum alloy sheet (workpiece 5a) in this analysis. The horizontal axis in the graphs of FIG. 15 and FIG. 16 (x-axis in FIG. 11, y=0, z=0) has “0” at the center point of the end face of the welding electrode.

FIG. 12(b) shows the maximum attained temperature distribution of a cross section including the molten region during current application in the analysis using the welding electrode shown in FIG. 10(b), the step line (b) in the graph shown in FIG. 13 shows the change in the diameter of the molten region in this analysis, and the curve (b) in FIG. 15 shows the maximum attained temperature distribution of the surface (the surface in contact with the welding electrode) of the aluminum alloy sheet (workpiece 5a) in this analysis.

FIG. 12(c) shows the maximum attained temperature distribution of a cross section including the molten region during current application in the analysis using the welding electrode shown in FIG. 10(c), the step line (c) in FIG. 14 shows the change in the diameter of the molten region in this analysis, and the curve (c) in FIG. 16 shows the maximum attained temperature distribution of the surface (the surface in contact with the welding electrode) of the aluminum alloy sheet (workpiece 5a) in this analysis.

FIG. 12(d) shows the maximum attained temperature distribution of a cross section including the molten region during current application in the analysis using the welding electrode shown in FIG. 10(d), the step line (d) in FIG. 14 shows the change in the diameter of the molten region in this analysis, and the curve (d) in FIG. 16 shows the maximum attained temperature distribution of the surface (the surface in contact with the welding electrode) of the aluminum alloy sheet (workpiece 5a) in this analysis.

In the analysis using the conventional welding electrode (without grooves) shown in FIG. 10(a), as shown by the step line (a) in FIG. 13, the molten region was not formed during the time period in which the current applied to the workpiece was 4 kA, and when the current was set to 15 kA, the diameter of the molten region gradually increased and reached about 5.4 mm.

In the analysis using the welding electrode shown in FIG. 10(b), as shown by the step line (b) in FIG. 13, when a current of 4 kA was applied to the workpiece, a molten region having a diameter of about 3.3 mm was immediately formed, and when the current was set to 15 kA, the diameter of the molten region gradually increased and reached about 6.5 mm.

In the analysis using the welding electrode shown in FIG. 10(c), as shown by the step line (c) in FIG. 14, when a current of 4 kA was applied to the workpiece, a molten region having a diameter of about 2.3 mm was immediately formed, and when the current was set to 15 kA, the diameter of the molten region gradually increased and reached about 6.3 mm.

In the analysis using the welding electrode shown in FIG. 10(d), as shown by the step line (d) in FIG. 14, when a current of 4 kA was applied to the workpiece, a molten region having a diameter of about 2.1 mm was immediately formed, and when the current was set to 15 kA, the diameter of the molten region gradually increased and reached about 6.5 mm.

From these analysis results, it was found that in the analysis using the conventional welding electrode without grooves (FIG. 10(a)), the molten region was not formed when the current applied to the workpiece was 4 kA, whereas in the analysis using the welding electrode with grooves formed in the end face (FIGS. 10(b) to 10(d)), the molten region was formed even when the current applied to the workpiece was 4 kA. In particular, in the analysis using the welding electrode shown in FIG. 10(b) with a higher density of grooves at the center of the end face, a molten region having a diameter of about 3.3 mm was formed even when the current applied to the workpiece was 4 kA.

Further, in the analysis using the conventional welding electrode, the maximum diameter of the molten region was about 5.4 mm, whereas in the analysis using the welding electrodes with grooves formed in the end face, a molten region having a diameter exceeding 6.3 mm was formed.

As shown in the graphs of FIG. 15 and FIG. 16, in the analyses using the welding electrodes with grooves formed in the end face (FIGS. 10(b) to 10(d)), the maximum attained temperature of the surface of the aluminum alloy sheet was higher than that in the analysis using the conventional welding electrode (FIG. 10(a)), but the temperature in the central portion was 450° C. to 500° C., and the surface of the alloy sheet did not reach the melting point of the aluminum alloy.

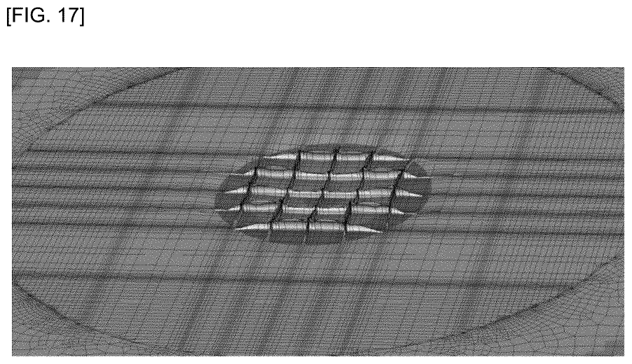

FIG. 17 is an analytical model of the surface shape of the aluminum alloy sheet at the initial stage of current application in the analysis using the welding electrode shown in FIG. 10(b). When the aluminum alloy sheet was pressed and applied with current by a welding electrode having grooves in a grid pattern on the end face, the surface of the alloy sheet was deformed so that a part of the aluminum alloy sheet entered the grooves as shown in the analytical model of FIG. 17. As a result, it was found that the surface oxide film of the aluminum alloy sheet was cut by the edges of the grooves, and the metal of the aluminum alloy sheet and the welding electrode make contact with each other without intervention of the surface oxide film.

### REFERENCE SIGNS LIST

2a, 2b, 2: welding electrode, 3: end face, 4a to 4n, 4: groove, 5a, 5b, 5: workpiece, 6: nugget, 7: surface oxide film, 8: pressure actuator, 9: arm, 10: power supply device, 11: blind hole, 12: rotary cutter, 13: housing, 15: tip dresser, 16: convex portion, 20: welding apparatus

What is claimed is:

1. A welding electrode used for spot welding of a workpiece, wherein
the welding electrode comprises an end face provided so as to contact the workpiece, and at least one elongated groove provided in the end face or a plurality of blind holes provided in the end face,
a depth of the groove or a depth of the blind holes is 0.5 mm or more and 20 mm or less,
the width of the groove or the size of the blind holes is 0.01 mm or more and 0.5 mm or less,
a ratio (d/w) of the depth d of the groove to a width w of the groove or a ratio (d/s) of the depth d of the blind holes to a size s of the blind holes is 2 or more,
the width of the groove is substantially constant in the depth direction, and
the size of the blind holes is substantially constant in the depth direction.

2. The welding electrode according to claim 1, wherein
the welding electrode comprises a plurality of grooves including the groove, and
the plurality of grooves are provided in a grid pattern.

3. (canceled)

4. The welding electrode according to claim 1, wherein
the welding electrode comprises a plurality of grooves including the groove, and
the plurality of grooves or the plurality of blind holes are provided so that a density of the grooves or a density of the blind holes at a center of the end face is higher.

5. The welding electrode according to claim 1, wherein the end face has a dome shape with a radius of curvature of 15 mm or more and 60 mm or less.

6. A welding apparatus comprising:
at least one welding electrode according to claim 1; and
a power supply device electrically connected to the welding electrode,
wherein the welding electrode and the power supply device are configured to apply an output current of the power supply device to the workpiece via the welding electrode.

7. The welding electrode according to claim 1, wherein a ratio (d/w) of the depth d of the groove to a width w of the groove or a ratio (d/s) of the depth d of the blind holes to a size s of the blind holes is 4 or more.
